(19) United States
(12) Patent Application Publication
(10) Pub. No.: US 2005/0271869 A1
(43) Pub. Date: Dec. 8, 2005

(54) Hierarchically-dimensioned-microfiber-based dry adhesive materials

(76) Inventor: Warren B. Jackson, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/863,129

(22) Filed: Jun. 7, 2004

(51) Int. Cl. B32B 27/04; B32B 27/12; B32B 27/08

(52) U.S. Cl. 428/297.4; 428/473.5; 428/474.4; 428/480; 428/412

(57) ABSTRACT

Embodiments of the present invention include hierarchically-dimensioned, microfiber-based dry adhesive materials featuring dense arrays of microfibers with free tips terminating in numerous microfibrils. In certain embodiments, more than two levels of microfiber-dimension hierarchy may be employed, each dimension involving smaller microfibrils emanating from the tips of the microfibers or microfibrils of the next highest dimensional level. Various additional embodiments of the present invention are directed to methods for preparing hierarchically-dimensioned, microfiber-based dry adhesive materials. These methods include single-pass or multi-pass imprint-lithography, pattern masking and etching, and imprinting fiber-embedded substrates followed by etching.

### TECHNICAL FIELD

The present invention is related to dry adhesive materials and, in particular, to adhesive materials with a dense array of microfibers protruding from a surface, the free end of each microfiber terminating in numerous microfibrils that can readily conform and bind, through van der Waals forces, to a wide variety of materials with different material compositions.

### BACKGROUND OF THE INVENTION

The climbing ability of geckos has been a source of delight and fascination for several millennia. Serious scientific investigation of the underlying principles of the gecko's ability to adhere to and move across flat, vertical and inverted surfaces, such as the interior walls and ceilings of houses, have been carried out for over a century. During the past few years, the principles behind gecko adhesion have finally been revealed. FIG. 1 shows a gecko extending its left, front, 5-toed paw. As can be easily seen in FIG. 1, the underside of the gecko's toes features a series of striations, or bands. FIG. 2 shows an enlarged image of a gecko paw, with the striations, or bands on the underside of the toes prominently displayed. The striations, or bands, on the undersides of gecko toes, are formed from groups of tiny hairs, called lamellae. Each lamella, in turn, is composed of tiny hairs, called setae that range between 5 and 10 microns in width, and between 30 and 130 microns in length. FIG. 3 illustrates rows of lamellae within a striation or band of hairs on the underside of a gecko toe. FIG. 4 illustrates a single seta. As shown in FIG. 4, the setae is stalk-like at its base 402, but terminates in a whisk-like set of even tinier fibrils. These tiny fibrils are called spatulae, with widths of between 0.2 and 0.5 microns. FIG. 5 shows a dense clump of spatulae at the end of a single seta. Note that the spatulae end in small, cup-like features.

Recent investigations have revealed that gecko adhesion arises from van der Waals attractions between the tiny spatulae on the underside of gecko toes and surfaces that the toes are brought into contact with. Because of the density and extreme fineness of the spatulae, the gecko can achieve an extremely large contact area at microscale and submicroscale dimensions with a surface. Close contact between the spatulae and a surface gives rise to van der Waals attractions between the large protein molecules from which the spatulae are composed and the surface. Remarkably, geckos can adhere to both hydrophobic and dry hydrophilic surfaces.

In general, van der Waals forces are relatively weak. An important aspect of gecko adhesion is that the gecko spatulae can be brought into close contact with a surface, at microscale and submicroscale dimensions, with an extremely small expenditure of energy. The resulting adhesive forces are essentially the sum total of van der Waals forces minus the energy expended to place the setae and spatulae into close proximity with a surface at microscale and submicroscale dimensions, including energy used for bending and orienting the setae and spatulae. The extremely dense and flexible brush of spatulae-tipped setae can conform to a surface at microscale and submicroscale dimensions with very little energy expenditure.

A question that has interested researchers is how gecko adhesion is controlled. The adhesive force generated by van der Waals interactions between a single gecko paw and a general surface is sufficient to support between many hundreds of grams to tens of kilograms of weight. However, the gecko is able to quickly and reversibly adhere to surfaces as it runs up and down vertical walls and across ceilings. Recent research reveals that the adhesive forces are strongly dependent on the angle between the shaft of a seta and the surface to which spatulae affixed to the seta adhere. FIGS. 6A-B illustrate reversible gecko adhesion. In FIG. 6A, a seta 602 is inclined at an angle less than 30° with a surface 604 to which the spatulae, including spatula 606, branching from the end of the setae adhere. When the angle of the shaft of the seta is less than 30°, as shown in FIG. 6A, the spatulae are in positions to closely adhere to the surface 604 through van der Waals forces without a large expenditure of energy needed to position them. However, as shown in FIG. 6B, when the angle of the shaft of the setae 602 with respect to the surface 604 increases past 30°, the spatulae are essentially peeled away from the surface one or several row of lamellae at a time, similar to peeling adhesive tape from a surface by lifting an end of the adhesive tape up off the surface and peeling the adhesive tape away from the surface along the length of the adhesive tape. When the angle of the seta is greater than 30° with respect to the surface, it is not possible for the spatulae to easily conform to the surface and adhere through van der Waals forces. Thus, a gecko can securely cling to a vertical wall when the inner surfaces of its toes are parallel to, or at a low angle with respect to, the vertical wall, but the gecko can quickly remove a paw from the wall by tilting the paw upward to an angle greater than 30°, peeling the spatulae from the surface a lamella row at a time. Van der Waals forces decrease exponentially with distance of separation between molecules or surfaces, and are therefore very short-range forces. Once a seta is angled away from a surface at an angle greater than 30°, almost no residual adhesive force remains.

Another interesting property of the gecko dry adhesion is that the bands of fibrils on the underside of the gecko's toes generally do not become laden with particulate matter. Were gecko adhesion a result of normal, chemical adhesion, one would expect that after a gecko traversed a dirty wall, the gecko's footpads would become soiled and ineffective. However, it turns out that particulate matter generally exhibits van-der-Waals-based attraction to surfaces, such as walls or tree bark, comparable to, or greater than that exhibited towards gecko spatulae. In fact, the fibrils of a gecko toe pad are essentially self-cleaning, with any particulate matter initially clinging to the toe pads generally removed by van der Waals attractions of the particulate matter to the surface along which a gecko traverses.

The elucidation of the principles behind gecko adhesion has spurred significantly research and development effort aimed at developing gecko-like fibril-covered surfaces that would adhere, via van der Waals forces, to a surface to which they are applied. Such dry adhesives would have huge advantages over currently employed adhesives. For example, liquid or semi-liquid adhesive compounds generally leave chemical residues on surfaces after the adhesive bond is broken. When traditional adhesives are used in applications involving many cycles of adhesive bond making and breaking, the traditional adhesives generally quickly pick up sufficient particulate matter to decrease subsequent adhesion to below useful levels. Such adhesive cannot be used, for example, for climbing or resealing applications. Additional problems involved with current adhesives include chemical instability of adhesive compounds over time and after exposure to solvents, electromagnetic radiation, oxidants, and other agents which chemically alter the adhesive compounds. Furthermore, solvents, plasticizers, and cross-linking agents incorporated into currently used chemical solvents may be volatile or may be easily solvated by environmental liquids or vapors, and may damage or alter surfaces to which the adhesives are applied, or surfaces or components adjacent to surfaces to which the adhesives are applied. For all these reasons, microfibril-based, dry adhesive materials that mimic setae-and-spatulae-based gecko adhesion would be most desirable for an almost limitless number of different applications.

Some progress has been demonstrated in preparing microfiber-based adhesive materials. The currently produced materials have been prepared using electron-beam lithography and dry etching in oxygen plasma. However, these fabrication methods, similar to the methods used for manufacturing semi-conductor devices, are very expensive and therefore not commercially viable for producing commercial quantities of adhesive materials. Moreover, the microfiber-based adhesive surfaces so far produced have not been particular durable. Therefore, researchers and developers of adhesive materials, and, in particular, researchers and developers seeking to mimic gecko adhesion in microfibril-based materials, have recognized the need for better materials and methods for economically producing microfibril-covered materials exhibiting dry adhesion via van der Waals attraction to surfaces.

### SUMMARY OF THE INVENTION

Embodiments of the present invention include hierarchically-dimensioned, microfiber-based dry adhesive materials featuring dense arrays of microfibers with free tips terminating in numerous microfibrils. In certain embodiments, more than two levels of microfiber-dimension hierarchy may be employed, each dimension involving smaller microfibrils emanating from the tips of the microfibers or microfibrils of the next highest dimensional level. Various additional embodiments of the present invention are directed to methods for preparing hierarchically-dimensioned, microfiber-based dry adhesive materials. These methods include single-pass or multi-pass imprint-lithography, pattern masking and etching, and imprinting fiber-embedded substrates followed by etching.

### BRIEF DESCRIPTION OF THE DRAWINGS

FIG. 1 shows a gecko extending its left, front, 5-toed paw.

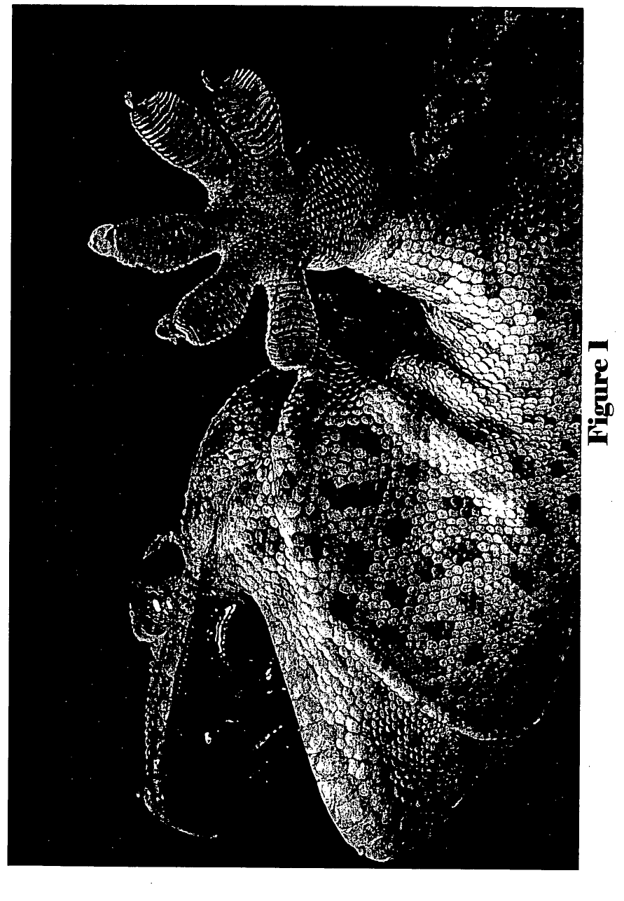

FIG. 2 shows an enlarged image of a gecko paw, with the striations, or bands on the underside of the toes prominently displayed

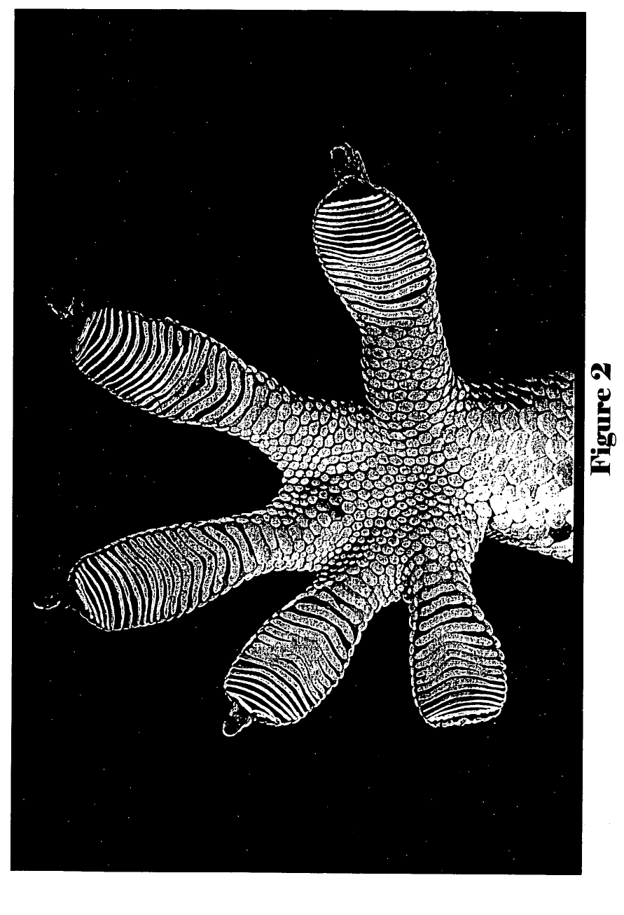

FIG. 3 illustrates rows of lamellae within a striation or band of hairs on the underside of a gecko toe.

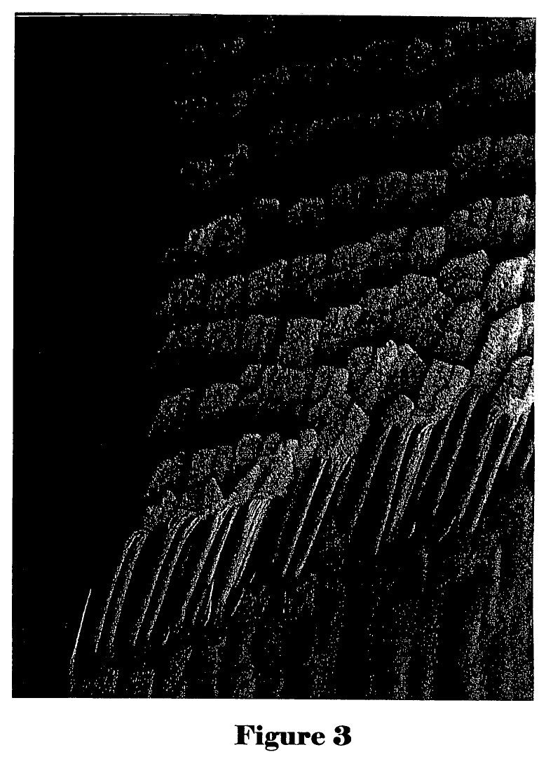

FIG. 4 illustrates a single seta.

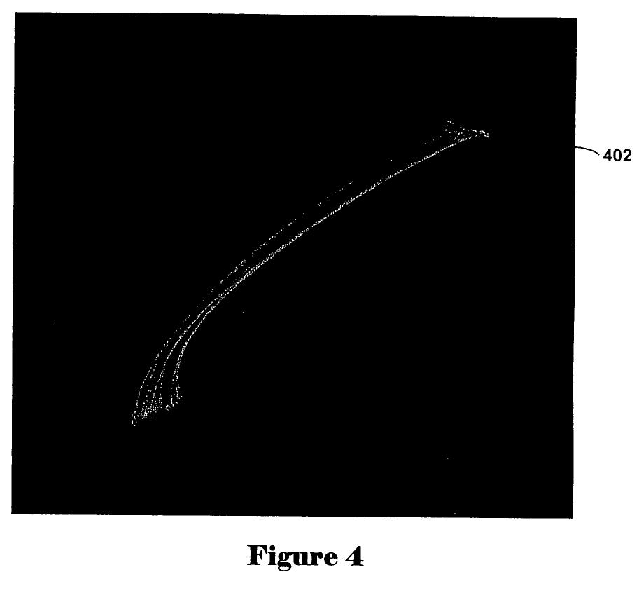

FIG. 5 shows a dense clump of spatulae at the end of a single seta.

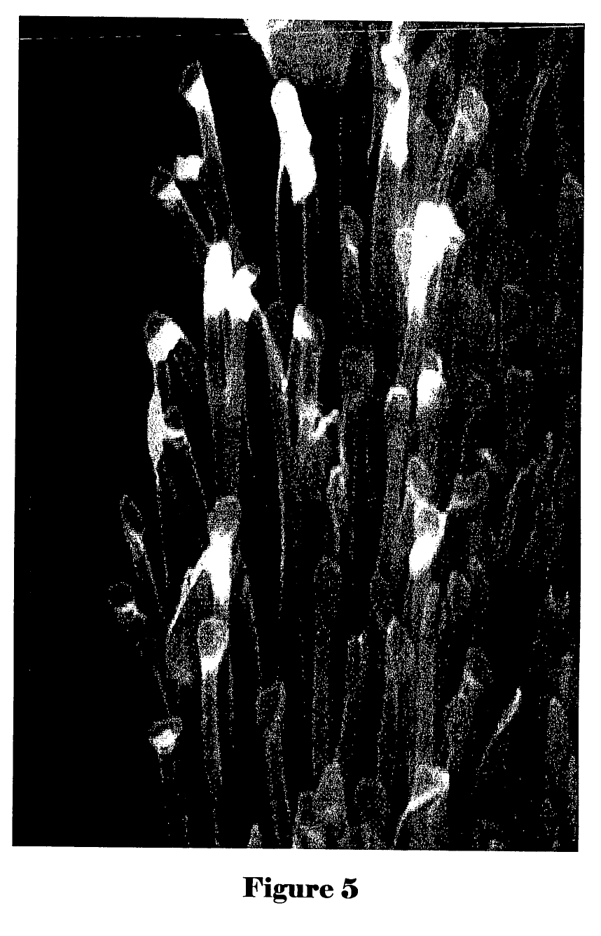

FIGS. 6A-B illustrate reversible gecko adhesion.

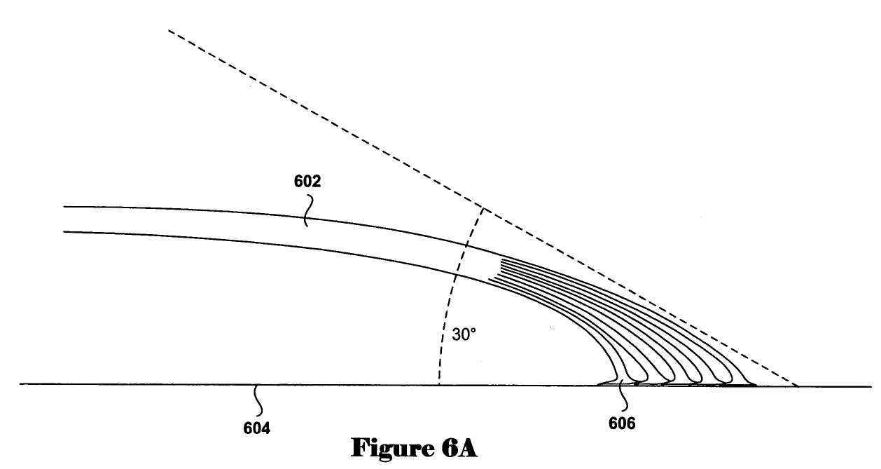

FIGS. 7A-B illustrate advantages of a two-tiered hierarchy of fiber sizes.

FIGS. 8A-D illustrate a first, general method for producing a hierarchically-dimensioned, microfiber-based dry adhesive material.

FIGS. 9A-C illustrate a second method for preparing hierarchically-dimensioned, microfiber-based dry adhesive materials.

FIG. 10 illustrates a third method for producing hierarchically-dimensioned, microfiber-based dry adhesive materials.

FIGS. 11A-C illustrate a fourth method for producing hierarchically-dimensioned, microfiber-based adhesive surfaces.

FIGS. 12A-B illustrate an embodiment employing a variant of the Bosch process.

FIG. 13 is an image showing a forest of tiny blades of RIE grass formed as a result of RIE-based microfabrication.

FIG. 14 shows a microfiber with three hierarchical levels of microfibril dimensions.

FIG. 15 is a control-flow diagram for a first method for preparing hierarchically-dimensioned, microfiber-based dry adhesive surfaces, illustrated above in FIGS. 8A-D.

FIG. 16 is a control-flow diagram illustrating a second method for preparing hierarchically-dimensioned, microfiber-based dry adhesive surfaces illustrated above, in FIGS. 9A-C.

FIG. 17 is a control-flow diagram for a direct, imprint-lithography method illustrated above in FIG. 10.

FIG. 18 is a control-flow diagram for the multi-step imprint-lithography method illustrated above in FIGS. 11A-C.

### DETAILED DESCRIPTION OF THE INVENTION

The present invention is related to gecko-like dry adhesives and, more particularly, to methods producing microfiber-based dry adhesives. Although many attempts have been made to manufacture gecko-like dry adhesives, the materials produced by these efforts have, so far, not shown acceptable durability, have not produced adhesive forces of magnitude equal to those produced by setae-and-spatulae-based gecko adhesion, and have suffered from very high cost of production, making them commercially infeasible.

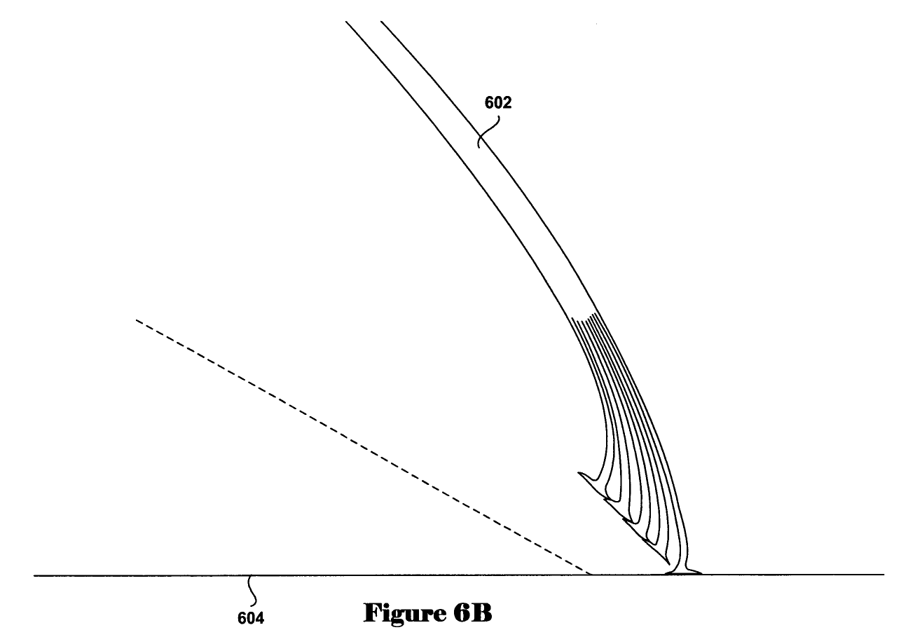

Most microfiber-based materials so far produced involve production of a dense mat of very fine microfibers, all of approximately similar sizes, and generally oriented perpendicularly to the surface of the adhesive material. However, as discussed above, gecko microfibers are almost fractal-like, with very tiny spatulae emanating from the tips of much larger, although still microscale, setae shafts. It turns out that the hierarchically dimensioned gecko fibers provide immense advantage in low energy conforming of the gecko microfibers to a given surface. FIGS. 7A-B illustrate advantages of a two-tiered hierarchy of fiber sizes. In FIG. 7A, the free ends microfibers on the order of several to 10 microns in width 702-704, presumably all affixed to a microfiber-based adhesive surface not shown in FIG. 7A, are contacting a surface 706 with a rough appearance at microscale dimensions. There is sufficient flexibility in the microfibers to allow the microfibers to somewhat adjust their angle of incidence to the surface in order to assume relatively stable positions with respect to the surface. However, as can be seen on FIG. 7A, only a small portion of the surface at the end of the microfibers 708-710 may end up directly contacting the surface. As discussed above, van der Waals forces are extremely short-range forces, so that unless a close contact is maintained over the entire surface to which adhesion is desired, the resulting adhesive forces may be relatively weak. Of course, if the surface shown in FIG. 7A were relatively planer and smooth at the microscale dimension, then relatively large portions of the ends of the microfibers may end up closely contacting the surface. However, that situation would require an extremely well-polished surface, by everyday surface standards, and would also require fairly strict tolerances for the length of the microfibers and the orientation of the microfiber-covered adhesive material to the polished surface. Commercial adhesives generally cannot rely on highly polished, planar surfaces and strict tolerances.

FIG. 7B shows, in contrast to FIG. 7A, the benefits of employing a two-tier hierarchy of microfiber dimensions, much as the two-tiered setae/spatulae system employed by the gecko. In FIG. 7A, each microfiber, such as microfiber 720, splays out into multiple submicro-fibrils, such as submicro-fibrils 722-728 emanating from the end of microfiber 720. The courser, larger-dimensioned microfibers have sufficient flexibility to allow them to adjust somewhat to conform to the relatively rough surface, at microscale dimensions, just as the microfibers in FIG. 7A. However, once adjusted at the coarser dimension, the tiny submicro-fibrils at the ends of the microfibers, also flexible, can then adjust to more closely conform to the surface. In essence, a two-tiered hierarchy of microfiber and submicro-fibril dimensions, such as shown in FIG. 7B, allows for essentially two levels of position and orientation adjustment in order to place the ends of the microfibrils in as close conformance as possible to complementary portions of a surface with which adhesion is desired. As noted above, dry, gecko-like adhesion critically depends on the energy expended in orienting the microfibers and microfibrils to conform to the surface to which they are applied being significantly less than the van der Waals attractive forces ensuing from the close contact. The two-tiered-microfiber-dimensions scheme provides the needed low-energy conformability. Low-energy conformability is also facilitated by having microfibers oriented at an angle less than 90° with respect to the surface of the dry adhesive, as in the relative low angle of the gecko septae, in contrast to current materials that attempt to simulate gecko adhesion using perpendicularly oriented fibers.

Thus, various embodiments of the present invention include hierarchically-dimensioned, microfiber-based dry adhesive materials that include at least two levels of microfiber dimensions, such as the microfibers and attached, microfibrils shown in FIG. 7B. These embodiments may be fashioned from any number of different types of materials, including crystalline materials, such as silicon and gallium arsenide, any number of different polymeric materials, including polymethylmethacrylate, polydimethylsiloxane, polyethylene, polyester, polyvinyl chloride, fluoroethylpropylene, lexan, polyamide, polyimide, polystyrene, polycarbonate, cyclic olefin copolymers, polyurethane, polyestercarbonate, polypropylene, polybutylene, polyacrylate, polycaprolactone, polyketone, polyphthalamide, polysulfone, epoxy polymers, thermoplastics, fluoropolymer, and polyvinylidene fluoride, composite materials, and other materials. The lengths of the microfibers and microfibrils, the widths of the microfibers and microfibrils, the spacing and packing arrangements of the microfibers and microfibrils, the shapes and densities of the microfibers and microfibrils, and the ranges in length and width of the microfibers and microfibrils may all be varied to fashion microfibril-based dry adhesive materials with specific, desirable adhesive properties. In addition, the number of hierarchical microfiber dimension levels may be varied in order to provide desired adhesive properties.

Additional embodiments of the present invention are directed to methods for preparing the hierarchically dimensioned, microfiber-based dry adhesive materials. These methods are directed to cheaply and efficiently covering or patterning surfaces of the above-mentioned crystalline or polymeric compositions in order to produce adhesive subsurfaces covered with a fine, brush-like forest of hierarchically dimensioned microfibers.

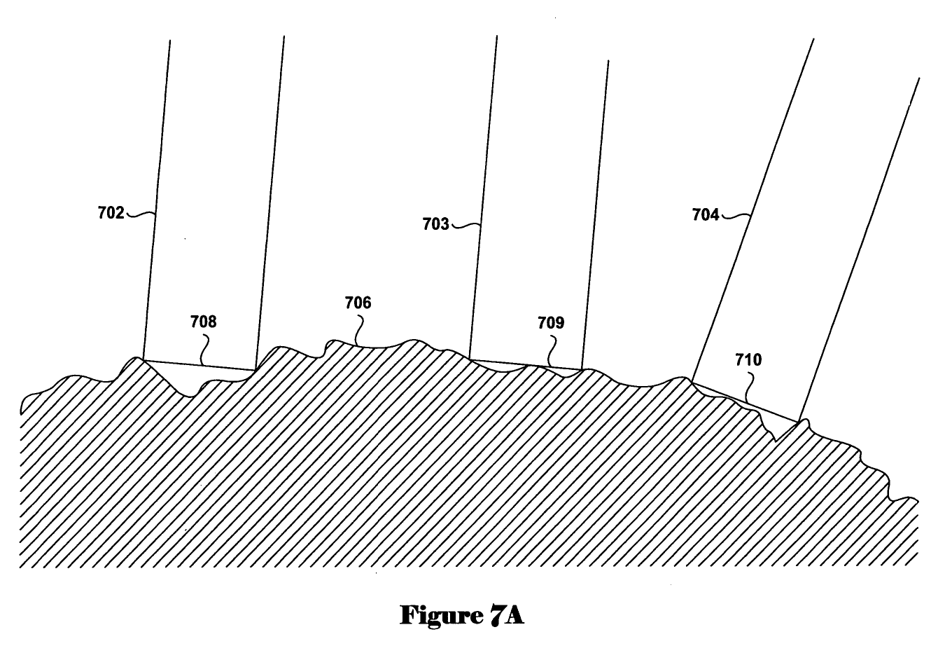

FIGS. 8A-D illustrate a first, general method for producing a hierarchically-dimensioned, microfiber-based dry adhesive material. As shown in FIG. 8A, a microfiber-embedded material 802 is chosen as the substrate. This material includes microfibers, such as microfiber 804, closely packed together and embedded in a polymer matrix, with the microfibers preferentially oriented neither perpendicularly nor parallel to the top and bottom surfaces of the substrate, as shown in FIG. 8A. The substrate can be produced by polymerizing a liquid polymer into which oriented microfibers have been inserted, or by chemically growing the microfibers, covering the chemically grown microfibers with a liquid polymer, and then crosslinking the polymer to produce a final microfiber-embedded substrate.

In a next step, shown in FIG. 8B, a microimprintable, uncrosslinked or partially crosslinked polymer layer is formed on, or affixed to, the top surface of the initial substrate. In FIG. 8B, the microimprintable layer 806 is shown as a formless, relatively thin layer placed upon the initial substrate 802. This second step may be optional in the case that the initial substrate is microimprintable. In a third step, illustrated in FIG. 8C, the top surface of the substrate is microimprinted to produce smaller microfibrils emanating from, or affixed to, the end surfaces of the embedded microfibers of the initial substrate.

In a fourth step, illustrated in FIG. 8D, the substrate is exposed to a crosslinking agent, such as UV radiation, to fix the micromprinting, and the microfibril layer is etched to remove imprinted microfibrils not emanating from, or affixed to, the ends of microfibers. Substrate is then etched to partially expose the microfibers embedded within the initial substrate. The etching may be carried out in different steps, or may be carried out in a single step. Many different types of chemical and plasma etching are well known in semiconductor manufacturing. The particular method chosen is based on the types of materials to be etched away and the types of materials desired to remain following etching.

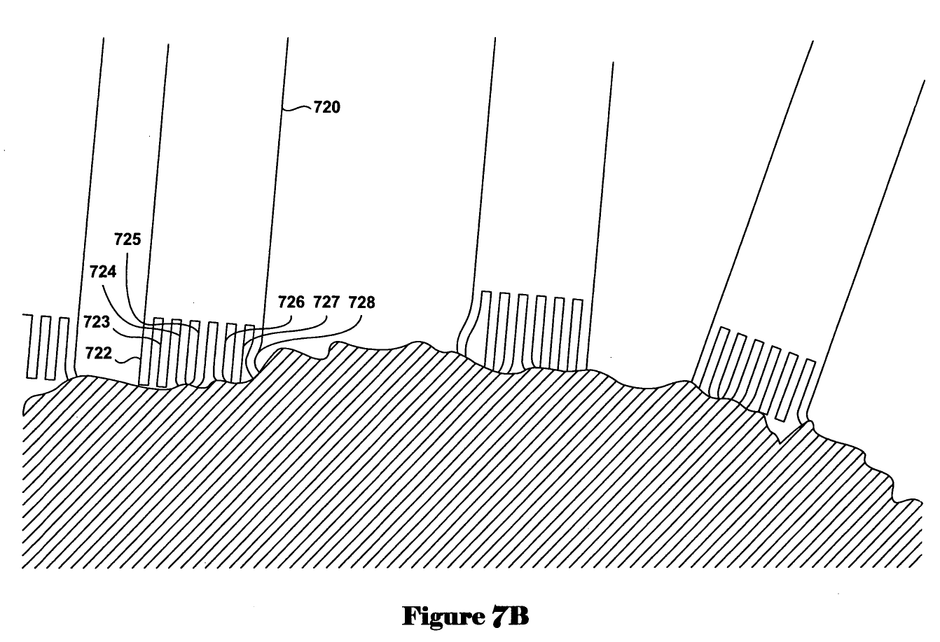

FIGS. 9A-C illustrate a second method for preparing hierarchically-dimensioned, microfiber-based dry adhesive materials. In a first step, as shown in FIG. 9A, a suspension of large, roughly spherical particles, such as particle 902, is poured onto a relatively simple substrate 904 and the solvent allowed to evaporate in order to generate a mask of relatively large particles, on the order of 7-15 microns in diameter, closely packed in two-dimensions on the surface of the simple substrate 904. The mask and substrate are then exposed to an anisotropic etching agent 906 that etches away substrate material not covered by the particles to produce closely packed, exposed microfibers on the surface of the substrate. The particles are then rinsed from the substrate.

In the second step, shown in FIG. 9B, the surface of the substrate, now comprising the ends of a number of protruding microfibers produced in the first step of FIG. 9A, is covered with a second suspension of smaller particles, such as particle 908, with diameters on the order of 0.2 to 0.5 microns. Again, the solvent is evaporated to produce a pattern mask, followed by exposure of the pattern mask and underlying substrate to an anisotropic etching agent 906. Following etching, any remaining particles are rinsed away to produce the final, hierarchically-dimensioned, microfiber-based adhesive material 910 shown in FIG. 9C. Note that in FIGS. 9A-B, the anisotropic etching agent has the same angular orientation to the substrate, so that the final submicron microfibrils are oriented similarly to the orientation of the larger microfibers from which they emanate. However, the microfibrils may have a markedly different orientation to the substrate than the microfibers from which they emanate if the angle of exposure of the anisotropic etching agent employed in the second step, shown in FIG. 9B, is different from the angle of exposure of the anisotropic etching agent used in the first step, shown in FIG. 9A.

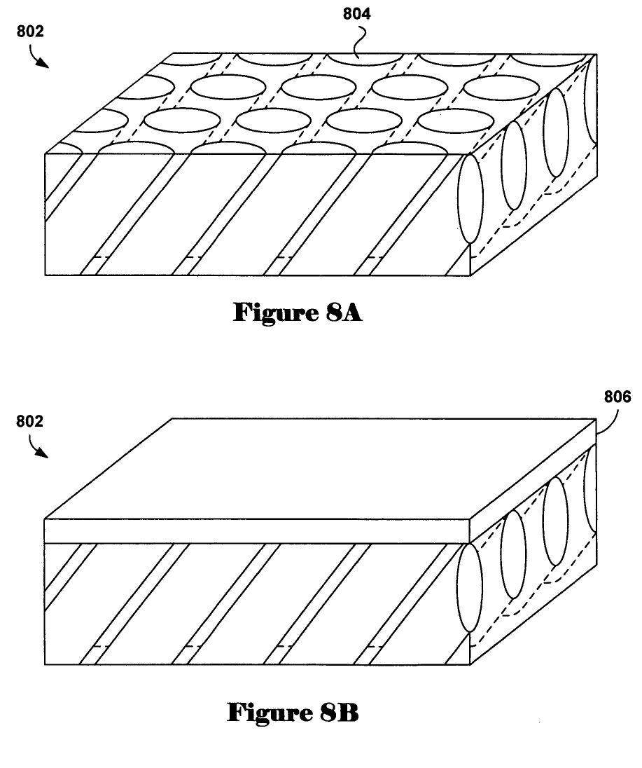

FIG. 10 illustrates a third method that may be used to produce hierarchically-dimensioned, microfiber-based dry adhesive materials. As shown in FIG. 10, a roll-based imprint-lithography mechanism 1002 can be precisely rolled across the surface of a substrate 1004 to concurrently imprint and crosslink the surface of the substrate so that the surface is covered by microfibers from which microfibrils emanate. In the imprint-lithography technique, UV radiation 1006 is transmitted through the transparent imprint-lithography roller 1002 to crosslink the surface of the polymer substrate as imprinting occurs. The imprinted surface can then be etched to remove uncrosslinked polymer in order to extend the microfibrils and microfibers to form a finished, dry-adhesive material.

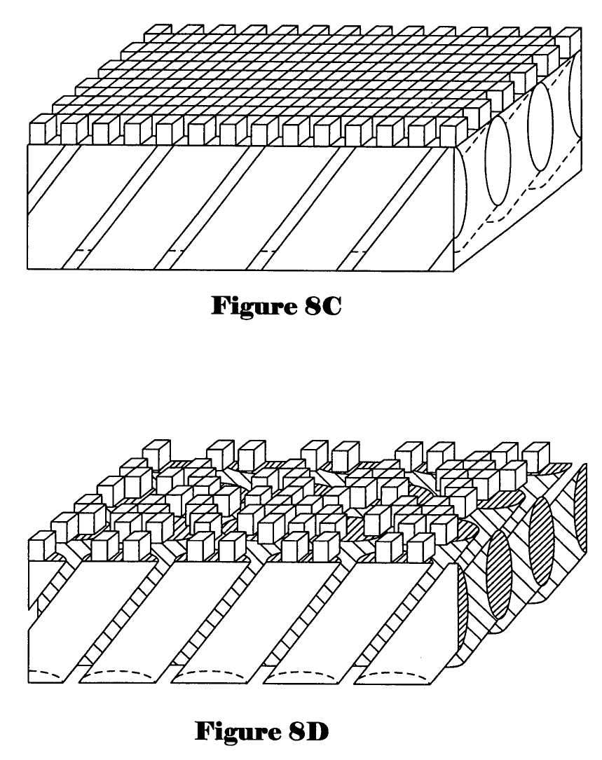

FIGS. 11A-C illustrate a fourth method for producing hierarchically-dimensioned, microfiber-based adhesive surfaces. In a first step, shown in FIG. 11A, imprint-lithography is employed to imprint the coarsely dimensioned microfibers onto the surface of a substrate 1104. The surface is etched, via anisotropic etching, to produced exposed microfibers emanating from the substrate surface, as shown in FIG. 11B. In a second step, imprint-lithography is used again to imprint the submicroscale microfeatures onto the ends of the exposed microfibers. A second, anisotropic etching step produces a finished, hierarchically-dimensioned, microfiber-based adhesive material, such as that shown in FIG. 9C.

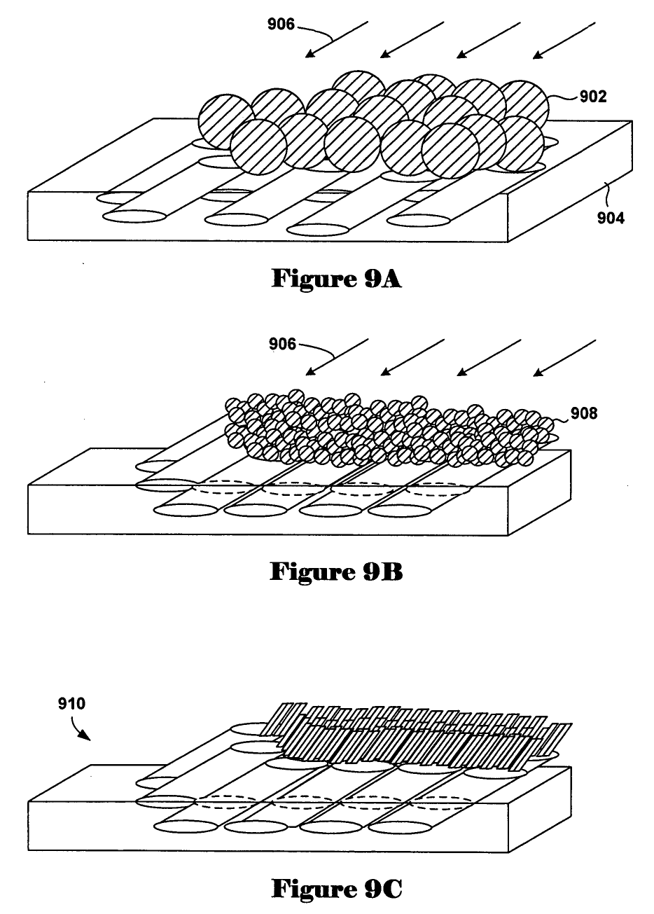

Additional methods for fabricating microfibers and microfibrils are possible. For example, a time multiplexed deep etching process, such as the Bosch process, can be employed. FIGS. 12A-B illustrate an embodiment employing a variant of the Bosch process. First, a patterned substrate, with photoresist patterned across the surface of the substrate is prepared using standard photolithographic techniques. Next, in step 1204, an initial isotropic etch using reactive ion species generated in a plasma is carried out to etch the substrate between the photoresist patterns. In step 1206, the exposed substrate surface is passivated—generally using a hydrocarbon gas, such as butane, which forms a fluorocarbon polymer passivation layer over the substrate surface, the fluorine contributed by the earlier etching step. Next, in step 1208, an anisotropic etch is carried out. The anisotropic etch may employ different reactive ions, depending on the substrate material, and may employ cooling from the backside of the substrate to facilitate anisotropic, versus isotropic, etching. Anisotropic etching destroys the passivation layer perpendicular to the incident reactive ions, and deepening the shallow wells produced in the initial etch, but leaves the side walls passivated, and extends the side walls in the direction of incidence of the reactive ions. Next, in step 1210, an additional isotropic etch may be employed to expand the wells both laterally and vertically, narrowing the pedestals below the remaining passivation layer. The surface is again passivated, in step 1212, and then, in step 1214, the widened and deepened well are further deepened by another anisotropic etch. The steps 1212 and 1214 can be repeated one or more times to further elongate the wells to produce a final array of microfibers with extremely large aspect ratios. The degree of anisotropic etching can be adjusted by pressure, power, chemical composition of the etchant gasses, and bias. One can also adjust the passivation part of the cycle to only passivate the top part of the sidewall allowing for more etching of the sidewalls as the trenching process proceeds.

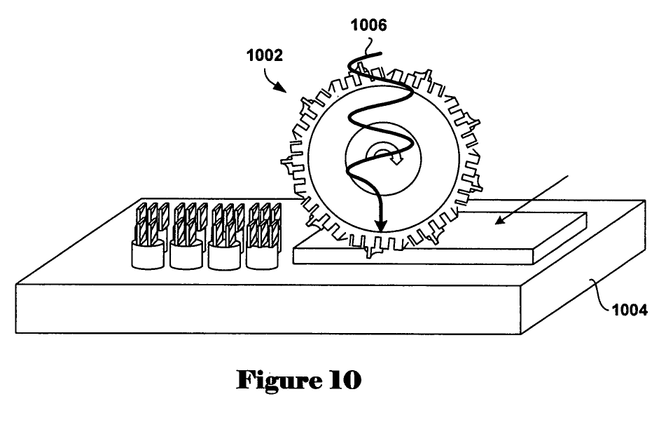

Another means for generating the microfibril portion of the structure involves intentional reactive ion etching (“RIE”) grass formation, a phenomenon commonly observed in RIE-based microfabrication. FIG. 13 is an image showing a forest of tiny blades of RIE grass formed as a result of RIE-based microfabrication. RIE-grass typically forms during RIE when there is concurrent etching and redeposition and/or inhomogeneous etch rates. Etch resistant portions of surfaces, often formed by sputtering from metal components, receive more material than the higher etch rate portions which lose material. Nascent blades grow taller and the inter-blade valleys become even deeper. RIE grass formation is normally a problem that must be eliminated by careful control of metal sputtering and changing the RIE conditions, but, for fabrication of microfibrils, both at the ends of microfibers as well as at the ends of already fabricated mircrofibrils, the metal sputtering and RIE conditions for RIE grass formation may be intentionally facilitated, rather than eliminated, in order to grow microfibrils. The RIE grass formation can be used to produce a second layer of fibrils, or, if applied to imprint produced fibrils, a third layer of submicron fibrils. Under some etching conditions, a fractal like hierarchy can be fabricated using the grass formation.

The fibrils can also be oriented in particular directions in order to optimize the structure for specific applications. For example, if fibers are oriented in a downwards direction, arrays of such structures may resist motion downwards better than if the fibers are oriented upwards. Such structures may provide oriented or non-isotropic adhesive forces that are able to resist forces better in some directions than in others. These structures may also serve as a ratchet, allowing two surfaces to slide in one direction, but not in an other. If arrayed in a circular pattern, preferential resistance to torque may be achieved.

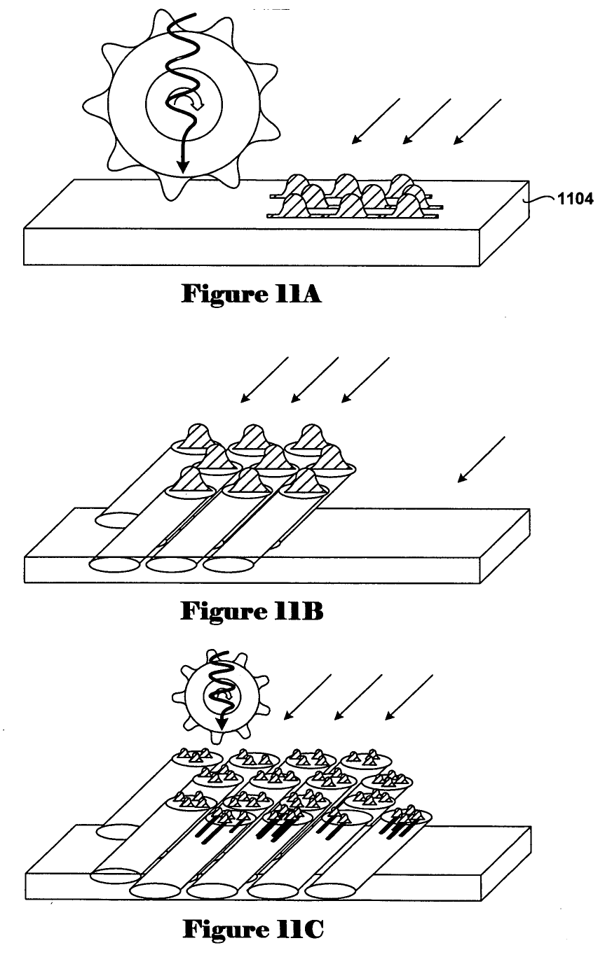

There may be additional advantages gained by introducing a third, fourth, or higher level of microfiber dimensional hierarchy. FIG. 14 shows a microfiber with three hierarchical levels of microfibril dimensions. In FIG. 14, intermediate-sized microfibrils, such as microfibril 1402, emanate from the end of a microfiber 1404, with smaller dimensioned microfibrils, such as microfibril 1406, emanating from the ends of the intermediate-sized microfibrils. A third tier in the hierarchical microfiber dimension may provide additional levels of orientation and position adjustment to facilitate conformance of the ends of the smallest microfibrils with a surface with which adhesion is desired. The numbers of levels of dimensional hierarchy may be viewed as a parameter that can be tuned to adjust the macroscopic properties of the dry adhesive material, or to make the dry adhesive material particularly effective with respect to certain types of surfaces.

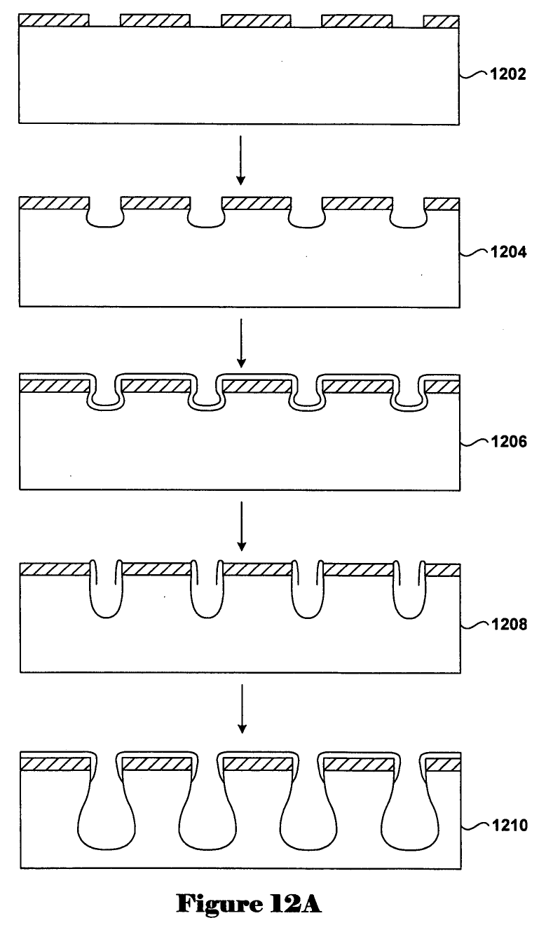

Next, simple control-flow-like diagrams are provided to illustrate various method embodiments of the present invention. FIG. 15 shows a control-flow diagram for a first method, illustrated above in FIGS. 8A-D. In the first step 1502, an initial substrate comprising oriented, closely packed microfibers within a polymer matrix is prepared. Next, in optional step 1504, the initial matrix is overlaid with an uncrosslinked or partially crosslinked polymer layer suitable for microstamping. As discussed above, in the case that the initial substrate is suitable for microstamping, this second step may not be necessary. Next, in step 1506, a roller-type microstamp is used to impress a microfibril pattern onto the surface of the substrate. Next, in step 1508, the micropattern surface is exposed to UV light, or another crosslinking agent, in order to affix the patterning. Next, in step 1510, the micropatterned substrate surface is etched to produce discrete, microfibrils. Finally, in step 1512, the substrate is again etched to remove the polymer matrix in which the microfibers are embedded. The time during which etching is carried in the etching steps may be varied to vary lengths of the microfibrils and microfibers. In certain embodiments, the second etching step may be unnecessary, in the case that both the microfibrils and microfibers can be effectively etched in a single step.

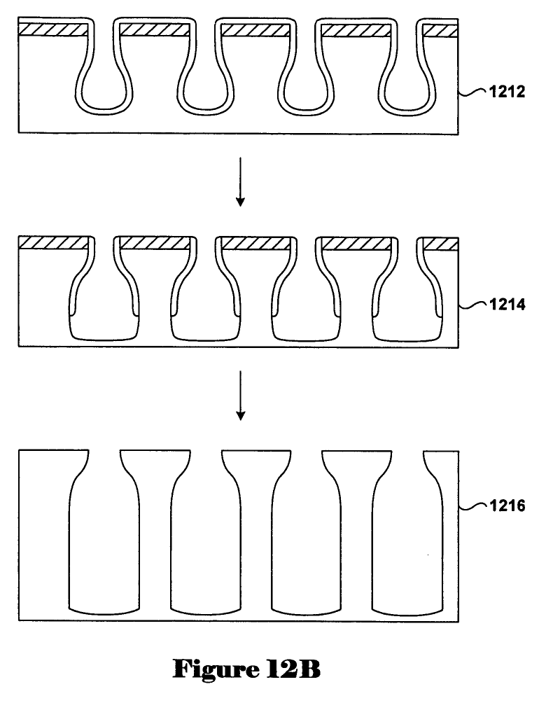

FIG. 16 is a control-flow diagram illustrating a second method for preparing hierarchically-dimensioned, microfiber-based dry adhesive surfaces illustrated above, on FIGS. 9A-C. In this simple-substrate method, a for-loop comprising steps 1602-1607 is repeated a number of times equal to the number of levels of hierarchical dimensioning desired in a final hierarchically-dimensioned, microfiber-based dry adhesive material. During each iteration, the surface of a substrate is coated with a suspension of particles in step 1603. Next, in step 1604, the solvent component of the suspension is evaporated to create a pattern mask comprising particles densely packed across the surface of the substrate. In step 1605, the pattern mask and substrate are exposed to an anisotropic etching agent in order to produce exposed fibers with diameters approximately equal to the diameters of the masked particles. Finally, in step 1606, any remaining particles are rinsed from the substrate. The size of the particles in the particle suspensions is decreased with each iteration of the for-loop comprising steps 1602-1607 to create smaller and smaller microfibrils at the ends of the microfibers or microfibrils produced in the previous step.

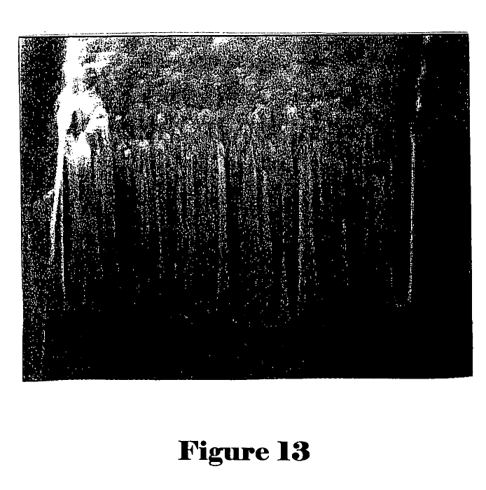

FIG. 17 is a control-flow diagram for a direct, imprint-lithography method illustrated above in FIG. 10. In step 1702, the imprint-lithography roller stamp is provided. In step 1703, a simple substrate is prepared for imprinting. Next, in step 1704, the imprint-lithography roller is rolled across the surface of the substrate to imprint a hierarchically-dimensioned, microfiber-based pattern onto the surface. Finally, in step 1706, the surface is anisotropically etched to expose the microfibers and microfibrils.

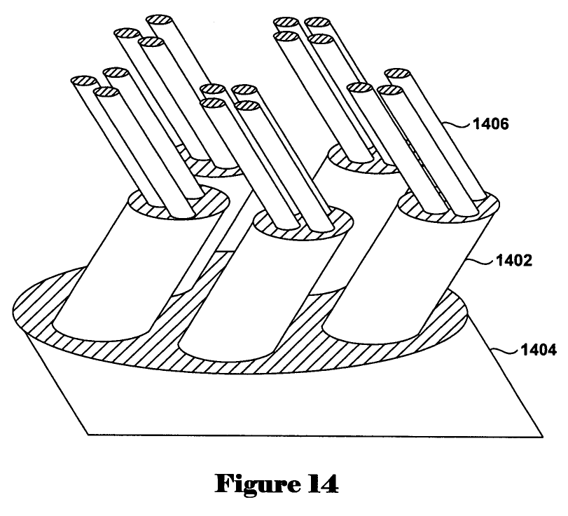

FIG. 18 is a control-flow diagram for the multi-step imprint-lithography method illustrated above in FIGS. 11A-C. This method consists of a for-loop comprising steps 1802-1804 repeated a number of times equal to the number of hierarchical-dimensioned tiers desired. In each iteration of the for-loop, the substrate is imprinted in step 1803, and then at, using anisotropic etching process, in step 1804.

Although the present invention has been described in terms of a particular embodiment, it is not intended that the invention be limited to this embodiment. Modifications within the spirit of the invention will be apparent to those skilled in the art. For example, many different variations and alternative embodiments are possible. For example, hierarchically-dimensioned, microfiber-based dry adhesive materials can be made out of many different types of materials, as discussed above, including crystalline materials, polymeric materials, composite materials, and other materials. It is possible that microfibrils may be chemically grown from the tips of microfibers via various synthetic techniques. Alternatively, it is possible that tiny microfibrils may self-aggregate at the ends of microfibrils or microfibers, following which a durable bond can be introduced via any of various synthetic or bond-introducing techniques. As discussed above, many of the techniques can be applied to produce two, three, or more levels of microfibril dimensions, further increasing and facilitating conformance of the microfiber-based dry adhesive material to a surface to which it is intended to adhere. The hierarchically-dimensioned, microfiber-based dry adhesive materials can be formed into adhesive tapes, ribbons, pads, and other adhesive materials for use in various different applications, including climbing pads, resealable enclosures for packaging, and adhesive surfaces on components for securing the components in larger system, such as electrical and mechanical components of electronic, computing, and data storage systems.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A hierarchically-dimensioned-micorfiber-based adhesive material comprising:
a substrate material; and
a dense array of microfibers protruding from a surface of the substrate, a free end the microfibers terminating in numerous microfibrils which adhere to a surface to which they conform by van der Waals forces.

2. The hierarchically-dimensioned-micorfiber-based adhesive material of claim 1 wherein a free end of a microfibril terminates in numerous smaller microfibrils.

3. The hierarchically-dimensioned-micorfiber-based adhesive material of claim 1 wherein the substrate comprises one of:
a crystalline or polycrystalline material;
a polymeric material; and
a composite material including microfibers embedded in a matrix.

4. The hierarchically-dimensioned-micorfiber-based adhesive material of claim 1 wherein the polymeric material is one, or a combination of:
polymethylmethacrylate;
polydimethylsiloxane;
polyethylene;
polyester;
polyvinyl chloride;
fluoroethylpropylene;
lexan;
polyamide;
polyimide;
polystyrene;
polycarbonate;
cyclic olefin copolymers;
polyurethane;
polyestercarbonate;
polypropylene;
polybutylene;
polyacrylate;
polycaprolactone;
polyketone;
polyphthalamide;
polysulfone;
epoxy polymers;
thermoplastics;
fluoropolymer; and
polyvinylidene fluoride.

5. The hierarchically-dimensioned-microfiber-based adhesive material of claim 1 formed into one of:
adhesive tape;
adhesive ribbon;
adhesive pads;
adhesive climbing pads;
adhesive component surfaces; and
resealable adhesive enclosures.

6. The hierarchically-dimensioned-microfiber-based adhesive material of claim 1 wherein a hierarchical layer of microfibers all have a similar orientation with respect to the surface of the substrate.

7. The hierarchically-dimensioned-microfiber-based adhesive material of claim 1 wherein a hierarchical layer of microfibers have a circularly varying pattern of orientations with respect to the surface of the substrate.

8. A method for producing hierarchically-dimensioned-micorfiber-based adhesive material, the method comprising:
selecting a substrate; and
iteratively
forming a next hierarchical dimension of microfibers on one or more substrate surfaces
until a desired number of microfiber hierarchical dimensions has been created.

9. The method of claim 8 wherein the selected substrate is a composite material with microfibers embedded in a solid or semi-solid matrix.

10. The method of claim 8 wherein the selected substrate is overlaid with a microimprintable layer.

11. The method of claim 8 wherein forming a next hierarchical dimension of microfibers on one or more substrate surfaces further includes microstamping a smaller-dimensioned level of microfibrils on the surfaces of the currently exposed, larger-dimensioned microfibers or microfibrils.

12. The method of claim 10 wherein, after forming a next hierarchical dimension of microfibers, etching is carried out to delineate and elongate the newly microstamped microfibrils.

13. The method of claim 10 wherein, after forming multiple hierarchical dimensions of microfibers, etching is carried out to delineate and elongate the dimensional levels of microstamped microfibrils.

14. The method of claim 8 wherein forming a next hierarchical dimension of microfibers on one or more substrate surfaces further includes:
selecting a suspension of particles with average diameters equivalent to the next hierarchical dimension;
coating the substrate with the suspension of particles;
evaporating solvent of the suspension from the substrate to produce a pattern mask comprising densely packed particles; and
anisotropically etching the substrate to produce the next hierarchical dimension of microfibers.

15. The method of claim 14 wherein the particles in the selected suspension have average diameters smaller than that of any particles previously used in preceding iterations to produce larger-dimensioned microfibers.

16. The method of claim 8 wherein forming a next hierarchical dimension of microfibers on one or more substrate surfaces further includes:
imprinting the next hierarchical dimension of microfibers by imprint lithography; and
etching to delineate and elongate the newly imprinted next hierarchical dimension of microfibers.

17. A method for producing hierarchically-dimensioned-micorfiber-based adhesive material, the method comprising:
selecting a substrate;
imprinting hierarchically-dimensioned microfibers onto the substrate by imprint lithography; and
etching to delineate and elongate the newly imprinted next hierarchical dimension of microfibers.

18. A method for producing a level of microfibers or microfibrils during production of a hierarchically-dimensioned-micorfiber-based adhesive material, the method comprising:
patterning a substrate with photoresist;
isotropically etching the patterned substrate to produce shallow wells between the photoresist patterns; and
extending the wells by one or more compound steps of
passivating the substrate surface, and
anisotropically etching.

19. The method of claim 18 further including, after executing a first compound step of passivating and anisotropically etching, isotropically etching to decrease the width of the microfibers or microfibrils of the level of microfibers or microfibrils.

20. A method for producing a level of microfibrils during production of a hierarchically-dimensioned-micorfiber-based adhesive material, the method comprising:
providing conditions conducive to RIE grass formation and elongation to grow a level of microfibrils at the ends of microfibers or microfibrils.
